(19) United States
(12) Patent Application Publication
(10) Pub. No.: US 2022/0132417 A1
(43) Pub. Date: Apr. 28, 2022

(54) Method and Apparatus for Providing Assistance Information for Improved Power Efficiency

(71) Applicant: Telefonaktiebolaget LM Ericsson (publ), Stockholm (SE)

(72) Inventors: Sina Maleki, Malmö (SE); Martin Van Der Zee, Malmö (SE); Ali Nader, Malmö (SE)

(21) Appl. No.: 17/428,319

(22) PCT Filed: Feb. 12, 2020
(86) PCT No.: PCT/EP2020/053574

§ 371 Date: Aug. 4, 2021

Related U.S. Application Data
(60) Provisional application No. 62/805,523, filed on Feb. 14, 2019.

(51) Int. Cl. H04W 52/02; H04W 76/28

(52) U.S. Cl. CPC H04W 52/0216; Y02D 30/70; H04W 76/28; H04W 52/0235

(57) ABSTRACT

Techniques are described for providing assistance information to the network that is useful in determining when to change an operating mode of the UE to reduce the power consumption of the UE. The assistance information may be used, for example, to release the UE from a RRC_Connected state; release one or more component carriers (e.g., SCells) in a set of aggregated carriers that are not being used, signaling the UE to go to sleep during an ON duration while an inactivity timer associated with a DRX configuration is running.

### TECHNICAL FIELD

The present disclosure relates generally to techniques for increasing power efficiency in a user equipment (UE) and, more particularly, to methods and apparatus for signaling assistance information to enable release of resources used for communication with the UE.

### BACKGROUND

Battery life for a user equipment (UE) is an important consideration for wireless communication networks. In New Radio (NR) systems, the network can help extend battery life of a UE by releasing resources that are not currently used by the UE to reduce the power consumption of the UE. For example, when a UE in Radio Resource Control (RRC) Connected (RRC_Connected) state is not expected to transmit or receive data, the network can release the RRC resources and allow the UE to transition to an Idle state. This not only saves UE power, but frees up resources that are currently being underutilized. Similarly, when carrier aggregation (CA) is used, Secondary Cells (SCells) not currently being used by a UE can be released. As another example, when a UE is in connected discontinuous reception (cDRX) mode, the UE can be signaled to go to sleep.

Although a number of techniques exists to reduce power consumption by the UE, these techniques rely primarily on buffer status reports (BSRs) and inactivity timers (IATs). The BSR informs the network about the status of the UE uplink transmit buffer. However, that BSR=0 does not mean that the UE does not expect any further UL data to send in the near future (e.g., 2-10 ms), or that no further DL data is expected in the near future. As a result, the network may release a RRC connection prematurely, which will cause the UE to go to an Idle state and perform a random access procedure when it needs to transmit data. Similarly, when a UE in cDRX mode wakes up to transmit or receive data, it starts an IAT and remains awake until the expiration of a timer. In this case, the UE may remain awake even when no data transmissions to or from the UE are expected.

### SUMMARY

The present disclosure relates to methods and apparats for providing assistance information to the network that is useful in determining when to change an operating mode of the UE to reduce the power consumption of the UE. Generally, the UE can be configured to provide the assistance information responsive to determining that no data transmission is expected. The assistance information may be used, for example, to release the UE from a Connected state, release one or more component carriers (e.g., SCells) in a set of aggregated carriers that are not being used, signaling the UE to go to sleep during an ON duration while an inactivity timer associated with a discontinuous reception (DRX) configuration is running.

Additionally, efficient and robust assistance information signaling through Layer1 (L1) and Layer2 (L2) signaling is provided on top of the existing Layer3 (L3) signaling methods. The signaling of assistance information by the UE as herein described enables the network to make better decisions regarding the release of the UE for long term (as in RRC release), or short term (as in DRX command or release SCell(s). As such the UE can save some power while its throughput and latency remains largely unaffected. Furthermore, the techniques as herein described provide faster, but still robust, signaling of the assistance information compared to the existing state of the art.

A first aspect of the disclosure comprises methods implemented by a UE for providing assistance information to the network for reducing power consumption. The UE determines that no data transmission is expected. Responsive to determining that no data transmission is expected, the UE transmits assistance information to the network. The assistance information comprises configuration information for power saving.

A second aspect of the disclosure comprises methods implemented by a base station for reducing power consumption of a UE in a wireless communication network. The base station receives assistance information from the UE. The base station further controls an operating mode of the UE based at least in part on the assistance information to reduce the power consumption of the UE.

A third aspect of the disclosure comprises a UE configured to perform the method according to the first aspect. In one embodiment, the UE comprises a communication circuit for communicating with a base station and a processing circuit. The processing circuit is configured to determine that no data transmission is expected. The processing circuit is configured to, responsive to determining that no data transmission is expected, transmit assistance information to the network. The assistance information comprises configuration information for power saving.

A fourth aspect of the disclosure comprises a base station configured to reduce the power consumption of a UE. In one embodiment, the base station comprises a communication circuit for communicating with the UE and a processing circuit. The processing circuit is configured to receive assistance information from the UE. The processing circuit is configured to control an operating mode of the UE based at least in part on the assistance information to reduce the power consumption of the UE.

A fifth aspect of the disclosure comprises a computer program for a UE. The computer program comprises executable instructions that, when executed by a processing circuit in the UE in a wireless communication network, causes the UE to perform the method according to the first aspect.

A sixth aspect of the disclosure comprises a carrier containing a computer program according to the fifth aspect. The carrier is one of an electronic signal, optical signal, radio signal, or a non-transitory computer readable storage medium.

A seventh aspect of the disclosure comprises a computer program for a base station. The computer program comprises executable instructions that, when executed by a processing circuit in the base station in a wireless communication network, causes the base station to perform the method according to the first aspect.

An eighth aspect of the disclosure comprises a carrier containing a computer program according to the seventh aspect. The carrier is one of an electronic signal, optical signal, radio signal, or a non-transitory computer readable storage medium.

### BRIEF DESCRIPTION OF THE DRAWINGS

FIG. 1 illustrates an exemplary wireless communication network.

FIG. 2 illustrates cDRX operation for reducing power consumption.

FIG. 3 illustrates an exemplary method implemented by a UE for signaling assistance information.

FIG. 4 illustrates another exemplary method implemented by a UE for signaling assistance information.

FIG. 5 illustrates another exemplary method implemented by a UE for signaling assistance information.

FIG. 6 illustrates an exemplary method implemented by a base station for controlling an operating mode of a UE to reduce power consumption.

FIG. 7 illustrates an exemplary method implemented by a base station for controlling an operating mode of a UE to reduce power consumption.

FIG. 8 illustrates another exemplary method implemented by a UE for signaling assistance information.

FIG. 9 illustrates an exemplary method implemented by a base station for controlling an operating mode of a UE to reduce power consumption.

FIG. 10 illustrates an exemplary UE according to an embodiment.

FIG. 11 illustrates an exemplary base station according to an embodiment.

FIG. 12 illustrates an exemplary UE according to another embodiment.

FIG. 13 illustrates an exemplary base station according to another embodiment.

FIG. 14 illustrates an exemplary wireless network according to an embodiment.

FIG. 15 illustrates an exemplary UE according to an embodiment.

FIG. 16 illustrates an exemplary virtualization environment according to an embodiment.

FIG. 17 illustrates an exemplary telecommunication network connected via an intermediate network to a host computer according to an embodiment.

FIG. 18 illustrates an exemplary host computer communicating via a base station with a user equipment over a partially wireless connection according to an embodiment.

FIGS. 19-22 illustrate exemplary methods implemented in a communication system, according to an embodiment.

### DETAILED DESCRIPTION

Referring now to the drawings, the assistance information signaling techniques will be described in the context of a wireless communication network 10 operating according to the Fifth Generation (5G) New Radio (NR) standards. Those skilled in the art will appreciate that the techniques disclosed herein are not limited to these radio access technologies (RATs) but are more generally applicable to wireless communication network operating according to any standards now know or later developed where power saving for the UE is desired including Long Term Evolution (LTE) networks, and Narrow-Band Internet of Things (NB-IoT) networks.

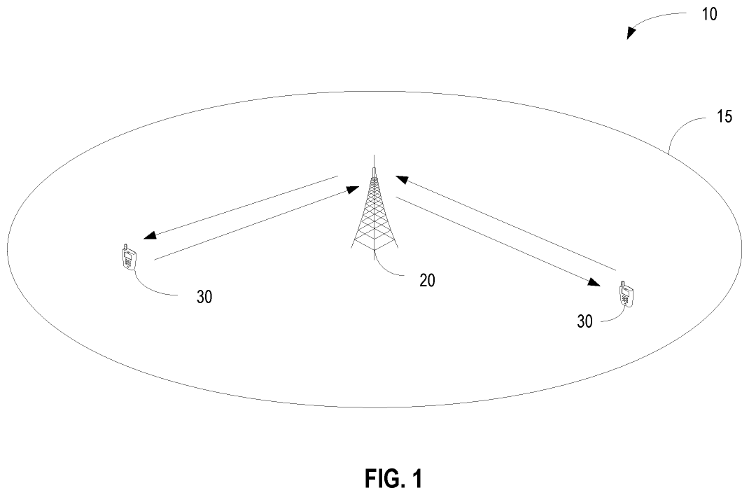

FIG. 1 illustrates communications between a base station 20 and a UE 30 in a wireless communication network 10. The base station 20, sometimes referred to in applicable standards as an Evolved Node B (eNB) or 5G Node B (gNB), is part of the 5G Radio Access Network (RAN) and provides radio coverage to the UE 30 in a cell 15 of the wireless communication network 10. The base station 20 provides connection to the 5G Core (5GC) network. The UE 30 may comprise, for example, a cellular telephone, smart phone, laptop computer, notebook computer, tablet, machine-to-machine (M2M) communication device (also referred to as machine-type communication (MTC) device), or other device with wireless communication capabilities. The base station 20 transmits data to the UE 30 in the DL on the Narrowband Physical Downlink Shared Channel (NPDSCH), the Narrowband Physical Downlink Control Channel (NPDCCH), and the Narrowband Physical Broadcast Channel (NPBCH). The UE 30 transmits data to the base station 20 in the UL on the Narrowband Physical Uplink Shared Channel (NPUSCH).

In order to communicate with the network 10, the UE 30 registers with the network 10 and establishes a Radio Resource Control (RRC) connection. When the UE 30 is registered with the network 10, the UE 30 can be in one of three different RRC states: RRC_CONNECTED; RRC_IDLE, RRC_INACTIVE. In RRC_CONNECTED state, referred to herein as the Connected state, the UE 30 has an established RRC connection with the 5G RAN/5GC. The UE 30 transitions to the Connected state for uplink and downlink data transfer. When the UE 30 is inactive for a period of time, the RRC connection can be released and the UE 30 can transition to the RRC-IDLE state, referred to herein as the Idle state. The UE 30 also enters Idle state on power up. While the UE 30 is in the Idle state, the UE 30 sleeps most of the time to conserve battery power and wakes up periodically to check for paging messages. The RRC_INACTIVE state, referred to as the Inactive state, is a new state introduced in NR. In the Inactive state, the UE 30 maintains an RRC connection but is inactive. This state allows the UE 30 to conserve battery power while allowing for faster transmission and lower signaling to return to the Connected state.

RRC Release

The UE 30 is switched to Idle or Inactive state through RRCRelease signaling. Because asynchronous Hybrid Automatic Repeat Request (HARQ) in the uplink is used, the UE 30 waits 60 ms after having received the RRCRelease message, or optionally when lower layers indicate that the receipt of the RRCRelease message was successfully acknowledged, whichever is earlier, before transitioning to the Idle state or Inactive state as described in 3GPP TS 38.331, section 5.3.8.3. In NB-IoT/MTC, when the UE 30 is not polled, the UE 30 may go to Idle state after having sent HARQ Acknowledgement (ACK) or negative acknowledgement (NACK).

When the UE 30 is polled in the release and the RLC report has been transmitted, due to the asynchronous HARQ in uplink, the UE 30 has to wait some additional time to ensure that the gNB has received the RLC ACK and to allow for possible HARQ retransmissions of the RRCRelease message if needed. It is important that UE 30 and network 10 remain RRC-state synchronized. For the Mobile Broadband (MBB) use case, the NR UE 30 is assumed to frequently transition between Connected and Inactive states (e.g., on average 20 RRC connection setups per hour per UE are observed in real life networks).

DataInactivityTimer

A DataInactivityTimer can be configured in the NR UE 30 to resolve RRC state mismatch in those rare cases where this can happen. When the radio link conditions are very bad, it is possible that the base station 20 exceeds the maximum number of RLC retransmissions for the RRCRelease message and goes to Idle state. It is possible that the UE 30 did not receive the RRCRelease message and remains in Connected state. Normally the UE 30 remains in Connected state when there is no data received. But when the DataInactivityTimer is configured and expires, the UE 30 goes to Idle state and performs a NAS recovery procedure, re-storing any RRC state mismatch.

Release Assistance Information (RAI) Signaling

In NB-IoT, when data is sent via the non-access stratum (NAS) (Control Plane (CP) solution), the UE 30 can indicate that it expects no further data to send or receive via NAS Release Assistance Indication (RAI) as described in 3GPP TS 24.301. The RAI comprises 2 bits and is used to indicates 1) that no further uplink or downlink data transmission is expected, or 2) that only a single downlink data transmission (e.g., acknowledgement or response to uplink data) and no further uplink data transmission subsequent to the uplink data transmission is expected. The purpose of the RAI information element (IE) in LTE is to inform the network that no further uplink data transmission is expected and whether or not a downlink data transmission (e.g. acknowledgement or response) subsequent to the uplink data transmission is expected.

The Mobility Management Entity (MME) can use this information to decide to release the S1 connection immediately, i.e., send the UE CONTEXT RELEASE COMMAND and trigger the base station 20 to release the RRC connection, or send the last downlink data followed by UE CONTEXT RELEASE COMMAND.

In NB-IoT, when data is sent via a data radio bearer (DRB) (User Plane (UP) solution), the UE 30 can indicate that it expects no further data to send or receive via BSR signaling, more explicitly by omitting sending BSR=0 when rai-Activation is configured (see 38.321).

In UMTS, the Signaling Connection Release Indication (SCRI) message, originally intended to indicate abnormal condition in the UE 30 and trigger an RRC connection release, has been (mis-)used to trigger a “fast dormancy”. However, with further standardization efforts, and timer/counter to control the potential excessive SCRI signaling, this feature has been successfully deployed. In LTE “fast dormancy” signaling is not supported.

In the current solutions for UE power savings in NR, the network 10 relies on the current DL/UL buffer status to release the UE 30 from a specific state, or operational mode, e.g. to release the RRC state of the UE 30 and send it to RRC_Inactive/Idle state from Connected state, or release a specific or a number of specific Scells, or send the UE to sleep in C-DRX mode. The network 10 becomes aware of uplink (UL) buffer through the Buffer Status Report (BSR) which is sent by the UE 30. While BSR=0 indicates that the UE 30 UL buffer is empty at the moment, it does not provide information about some short time afterwards, e.g. a couple of ms or 10s of ms. Thus, the network 10 may inappropriately send the UE 30 to Idle or Inactive state while the UE 30 expects so have some UL data to send or to a lesser extent data to receive. Therefore, there is a need for additional release assistance information from the UE through explicit signaling that the UE at least do not expect to UL any data.

One aspect of the disclosure comprises assistance information and signaling schemes to help the network 10 in making decision regarding releasing the NR UE 30 from a specific state or operational mode. Assistance information, also referred to herein as assistance information, is sent from the UE 30 to the network 10 to provide the network 10 information for releasing the UE 30 from the Connected state, releasing SCells that are not being scheduled, and for releasing the UE 30 from active state of DRX (i.e., On Duration or Inactivity timer (IAT)). Additionally, the signaling techniques for realizing efficient and robust signaling of assistance information through L1 and L2 signaling on top of the existing L3 signaling techniques.

Status Information for RRC Release

NR supports RRCRelease signaling to switch a UE 30 to an Idle or Inactive state from a Connected state. To do so, the network 10 has to rely only on the current downlink (DL) buffer as well as the buffer status report (BSR) from the UE 30. It should be noted that BSR=0 signaling indicating that the uplink (UL) buffer is currently empty does not mean that the UE 30 does not expect any further UL data to send in the near future, or that no further DL data is expected in the near future.

To reliably release the RRC connection, more information than is currently provided by the BSR is required. According to one aspect of the disclosure, assistance information signaling is used to indicate that no data is expected to be sent and/or received. The assistance information may further provide timing information to indicate a time span or duration over which no data transmission is expected. In some embodiments, the assistance information may indicate that only an additional DL transmission is expected with no UL transmission. Information about the number, amount or size of the data transmission can be provided. In one embodiment, if after a specific amount of time (similar to datainactivitytimer), the UE 30 can send assistance information to indicate that no more DL and/or UL transmissions are expected and so on. Accordingly, a bit field with specific length can be defined to include all possible combinations of the assistance information that may be indicated. Nevertheless, it would be beneficial to keep this as short as possible. The bit field can be transmitted in the form of uplink control information (UCI) on the NPUCCH or NPUSCH as hereinafter described.

Status Information For SCell(s) Release

As in the case of RRC connection, NR supports SCell release through SCell Deactivation command or the sCellDeactivationTimer. As in the case of RRC release, to allow or order release of a component carrier in a set of aggregated carriers, the base station 20 only has access to the current DL/UL information. Status information signaling as herein described can provide additional information about the UL/DL expectations from the UE side.

In this case, the assistance information can contain simple information such as the DL/UL expectations as in the case of RRC release, or some additional information such as the load of expected information, e.g., a simple low may indicate that additional SCell(s) are not necessary, and a high may indicate that the network 10 should not release the SCell(s). In another example, the UE 30 can indicate when it has reached a critical battery status so that releasing SCell(s) would be advantageous. For more enhanced assistance information, the UE 30 can indicate to the network 10, which SCell(s) can be released.

As in the case of assistance information for RRC release, a bit field can be defined indicating different assistance information for SCell release. Again, such a bit field should be kept as small as possible.

End-Of-Traffic-Burst (EOTB) Signaling For cDRX

In addition to assistance information signaling to assist RRC release or SCell release, additional signaling can be used on a finer time granularity, i.e. to assist the network 10 to switch the UE 30 into connected DRX (cDRX) using Long DRX or DRX Command Medium Access Control (MAC) Control Element (CE). Status information signaling for cDRX is on a different time scale than assistance information signaling for RRC release so that some additional information may be useful or required. For example, timing information in the assistance information can indicate to the network 10 whether RRC release or DRX is best.

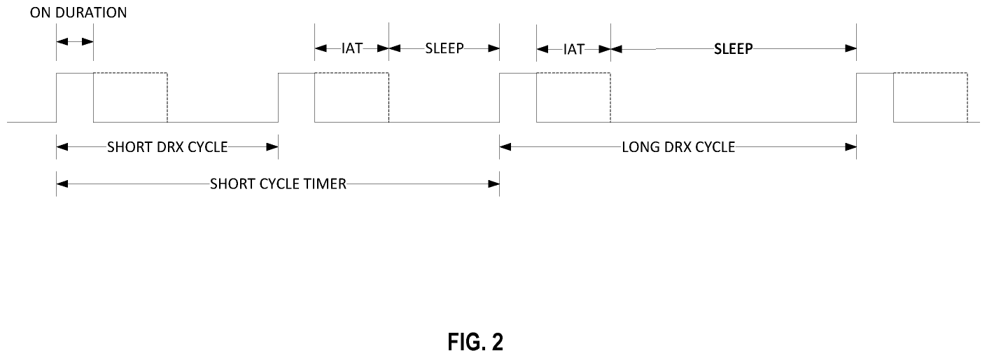

FIG. 2 illustrates a cDRX mode operation for a UE 30 in Connected state. In cDRX mode, the UE 30 alternates between an active state (awake) and a sleep state. The UE 30 periodically wakes to check for a data transmission. When UE 30 receives an allocation for an uplink or downlink data transmission, the UE 30 starts an inactivity timer after completion of the data transmission and remains awake until the timer expires. If no additional allocation is made, the UE 30 returns to a sleep state using a short DRX cycle. If no allocation is received after a predetermined time period determined by the Short Cycle Timer, the UE 30 switches to a long DRX cycle. The UE 30 remains in long cycle DRX until an allocation is received, at which time the UE 30 returns to an active mode and starts the inactivity timer.

Generally, it is beneficial to switch the UE 30 into cDRX when no new traffic burst is expected within 10's or 100's of ms instead of waiting for the drx-InactivityTimer to expire. Similarly, when an application running on the UE 30 is “done”, it makes sense to switch the UE 30 back to Inactive state as quickly as possible. The drx-InactivityTimer and network inactivity timer operate on a different time scale. A network 10 inactivity timer value is on a time scale of several seconds or 10's of seconds.

Therefore, when evaluating assistance information signaling for cDRX and RRC connection release, the evaluation should consider the time scale over which no more data is expected. For example, within the assistance information, the UE 30 can provide a time indication as part of the assistance information to indicate an amount of time over which it does not expect a UL/DL. The timing information may indicate a number of frames, a time scale (e.g., long or short), a specific time span, or a specific time duration. The network 10 can evaluate if the time span justifies an RRC release, a SCell release or a simple DRX command.

In another example, a certain bit field can be included as part of the assistance information payload explicitly indicating if the provided assistance information signal is related to RRC release, removal of a SCell release, or switch to a DRX mode.

Assistance Information Signal Design And Robustness Issues

The discussion so far has focused on three forms of assistance information signaling for UE power savings. There may be circumstances where such assistance information can be useful, but the specific examples given at least provide an idea of the range of options. Regardless of the type of assistance information signaling, the assistance information signaling scheme should be designed for robustness. In the following discussion, some examples of assistance information signaling design are provided and robustness issues are described.

As mentioned above, specific bit field(s) can be defined to cover useful information that can be provided by assistance information signaling. The information provided by the assistance information may include a data amount (e.g. high/low) for an expected data transmission, timing information, battery state, whether an RRC release and/or removal of a SCell is requested, etc. The timing information may include a number of frames, a time scale (e.g., long or short), a specific time span, etc. This timing information may be used for example, to determine whether a RRC release is justified.

While being inclusive as much as possible, such bit fields should remain as small as possible to save resources. For example, in one implementation, all the information regarding assistance information signaling for RRC release, DRX and SCell release can be combined in a single transmission. In another example, e.g., 2 bits can be used in order to refer to any of the three assistance information signaling mechanisms, leaving one combination reserved for future possible release options.

After defining the specific bit field, the remaining challenge is how to signal assistance information to the UE 30 and ensure robustness. Some of the possibilities are discussed below.

Assistance Information Design And Robustness Issues

Status information may be sent by the UE 30 to the network 10 via L1 signaling on the NPUCCH or NPUSCH. For example, the signaling may be carried out using L1 signaling by introducing assistance information in Uplink Control Information (UCI) transmitted on NPUCCH/NPUSCH. As another example, assistance information can be provided in a L2 MAC CE provided in the UL on the NPUSCH, or on L3 level through RRC signaling.

In terms of robustness, RRC signaling is the most robust option. Procedures based on RRC signaling are also well established can be reused quite easily. Nevertheless, RRC signaling is rather a slow procedure and particularly may not be the best option for SCell and EOTB signaling for DRX release.

The fastest procedure, on the other hand, is to send assistance information through the NPUCCH. In NR, 5 PUCCH formats 0-4 are defined. PUCCH formats 0 and 1 can accommodate two bits, while the other formats can accommodate more than two bits. In one approach, the network 10 can configure the UE 30 to send a specific combination of bits as assistance information, e.g. a negative scheduling request (SR), or define an SR inactivity timer after which if a negative SR is received, it will be interpreted as assistance information, e.g. the UE 30 indicates that it does not expect to send any data in UL and/or DL. This is simpler, as the current implementation of PUCCH remains intact.

On the other hand, the assistance information signal can be multiplexed or piggybacked with the other information, i.e., HARQ ACK/NACK, Channel State Information (CSI), and scheduling requests (SR). This approach is particularly beneficial if the assistance information payload has more than 2 bits, and thus needs to be sent through NPUCCH formats 2-4. As one example of piggybacking, the UE 30 may “borrow” bits allocated for one purpose to send the status indication similarly to the negative SR mentioned above. In other piggybacking example, the UE 300 multiplexes the assistance information with transmission of other UCI.

In another example, if there is no DL transmission, and hence no need for the UE 30 to transmit HARQ feedback on PUCCH, all the bits on PUCCH can be used for conveying the “assistance information” in an unsolicited PUCCH transmission for this specific UE 30. Special PUCCH resources could be set aside by the network 10 for this purpose. The special resources could be any of the special cyclic shifts, Orthogonal codes (OCCs), or special Physical Resource bocks (PRBs) and hopping pattern.

The main issue with sending assistance information through NPUCCH is robustness. While missing assistance information may not have large impact on the network 10, it mostly leads to a waste of energy at the UE 30. In case of false alarm, the network 10 may release the UE 30, while the UE 30 expects data to be sent or received. As such, the UE 30 has to start the random-access procedure to become connected again leading to increasing latency and lower throughput. One simple solution to this problem is that the UE 30 does not acknowledge the reception of release commands. However, if this approach is used too frequently, it may have negative impact on the network 10.

A middle approach that provides a fast procedure and better robustness is to send assistance information as UCI multiplexed with the NPUSCH, e.g. after the last UL transmission. Or as mentioned above, assistance information can be sent in a L2 MAC CE in the UL on PUSCH. One option is to use the reserved LCID indexes from Table 6.2.1-2 in the Third Generation Partnership Project (3GPP) standard TS 38.321 to send the assistance information over the uplink shared channel (UL-SCH) through NPUSCH. This approach is more robust than the NPUCCH one as it can involve a handshake procedure (due to ACK/NACK).

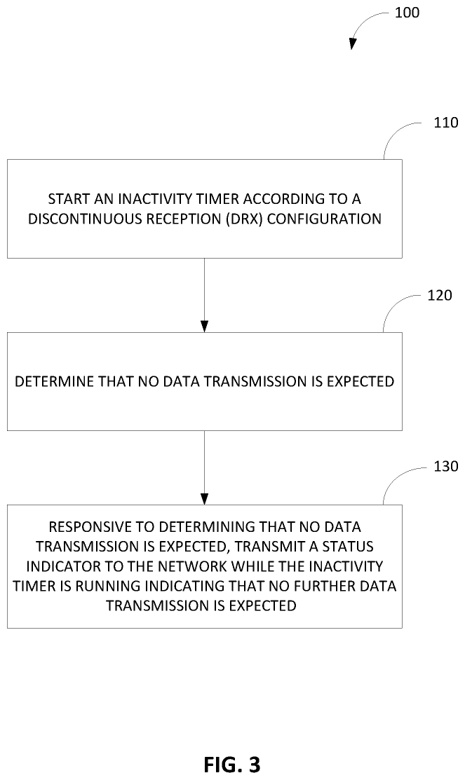

FIG. 3 illustrates an exemplary method 100 implemented by a UE 30 for reducing power consumption of the UE 30. The UE 30 starts an inactivity timer according to a discontinuous reception (DRX) configuration (block 110). The inactivity timer could be started when an allocation is received for the transmission, when the transmission begins, or when the transmission is complete. The UE 30 further determines that no data transmission is expected (block 120). Responsive to determining that no data transmission is expected, the UE 30 transmits a status indicator to the network 10 while the inactivity timer is running (block 130). The status indicator indicates to the network 10 that no further data transmission is expected.

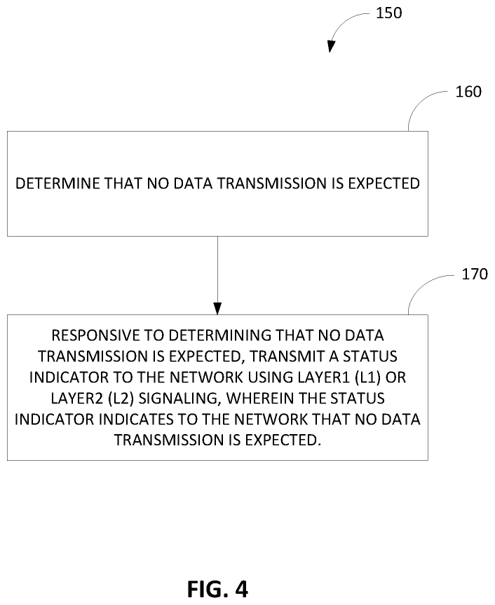

FIG. 4 illustrates an exemplary method 150 implemented by a UE 30 for reducing power consumption of the UE 30. The UE 30 determines that no data transmission is expected (block 160). Responsive to determining that no data transmission is expected, the UE 30 transmits a status indicator to the network 10 using Layer1 (L1) or Layer2 (L2) signaling (block 170). The status indicator indicates to the network 10 that no data transmission is expected.

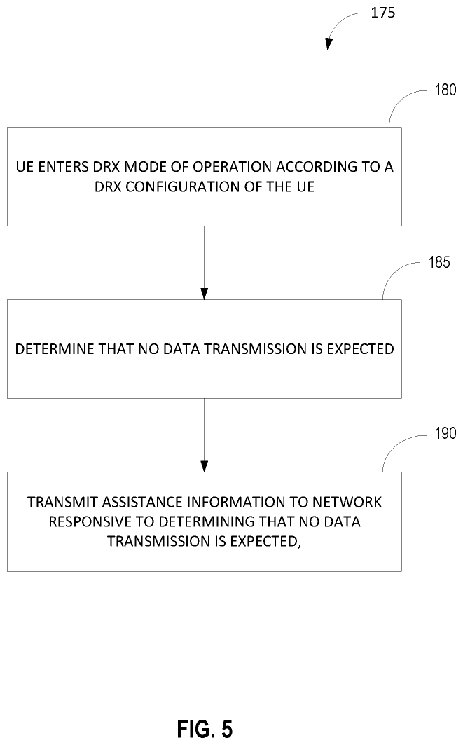

FIG. 5 illustrates an exemplary method 175 implemented by a UE 30 of signaling assistance information for reducing power consumption by a UE 30. The UE 30 enters a discontinuous reception (DRX) mode of operation according to a DRX configuration of the UE 30 (block 180). The UE 30 further determines, while in the DRX mode of operation that no data transmission is expected (block 185). Responsive to determining that no data transmission is expected, the UE 30 sends assistance information to the network (block 190). In some embodiments of the methods 100, 150 and 175, the status indicator indicates that no uplink transmission is expected.

In some embodiments of the methods 100, 150 and 175, the status indicator indicates that no downlink transmission is expected.

In some embodiments of the methods 100, 150 and 175, the status indicator indicates that neither an uplink transmission nor a downlink transmission is expected.

In some embodiments of the methods 100, 150 and 175, the status indicator further comprises a time indication indicative of a time period during which not data transmission is expected.

Some embodiments of the methods 100, 150 and 175 further comprise receiving, responsive to the status indicator, a control message from the network 10, and changing a mode of operation responsive to the control message.

In some embodiments of the methods 100, 150 and 175, the control message comprises a go-to-sleep signal and the method further comprises switching from an active mode to a DRX mode before expiration of the inactivity timer.

In some embodiments of methods 100, 150 and 175, the control message comprises a command to switch early from a short DRX cycle to a long DRX cycle.

In some embodiments of the methods 100, 150 and 175, the control message comprises a configuration message to change a DRX configuration of the UE responsive to the assistance information. For example, the configuration information could be used to change the length of a DRX cycle, or to change the duration of the inactivity timer. Those skilled in the art will appreciate that any change of DRX configuration that reduces UE power consumption could be made.

In some embodiments of the methods 100, 150 and 175, the control message comprises a release message and the method further comprises switching from a Connected state to an Idle state or Inactive state before expiration of the inactivity timer.

In some embodiments of the methods 100, 150 and 175, the control message comprises a release signal, and the method further comprises changing removing a cell from a cell from a set of aggregated carriers before expiration of the inactivity timer.

In some embodiments of the methods 100, 150 and 175, transmitting a status indicator to the network 10 comprises transmitting the status indicator in uplink control information transmitted on a shared uplink control channel.

In some embodiments of the methods 100, 150 and 175, transmitting a status indicator on a shared uplink control channel comprises multiplexing the status indicator with other control information transmitted on the shared uplink control channel.

In some embodiments of the methods 100, 150 and 175, transmitting a status indicator on a shared uplink control channel comprises transmitting the status indicator in a MAC CE transmitted on an uplink shared channel.

In some embodiments of the methods 100, 150 and 175, the UE 30 is configured by the network 10 to transmit a negative scheduling request during operation of the inactivity timer to serve as the status indicator.

In some embodiments of the methods 100, 150 and 175, transmitting a status indicator to the network 10 comprises transmitting a status indicator to the network 10 comprises transmitting the status indicator on an uplink shared channel used for transmission of user data.

In some embodiments of the methods 100, 150 and 175, transmitting a status indicator on an uplink shared channel comprises transmitting the status indicator in a MAC CE.

In some embodiments of the methods 100, 150 and 175, transmitting a status indicator on an uplink shared channel comprises multiplexing the status indicator with user data.

In some embodiments of the methods 100, 150 and 175, transmitting a status indicator to the network 10 comprises transmitting the status indicator in radio resource control (RRC) signaling.

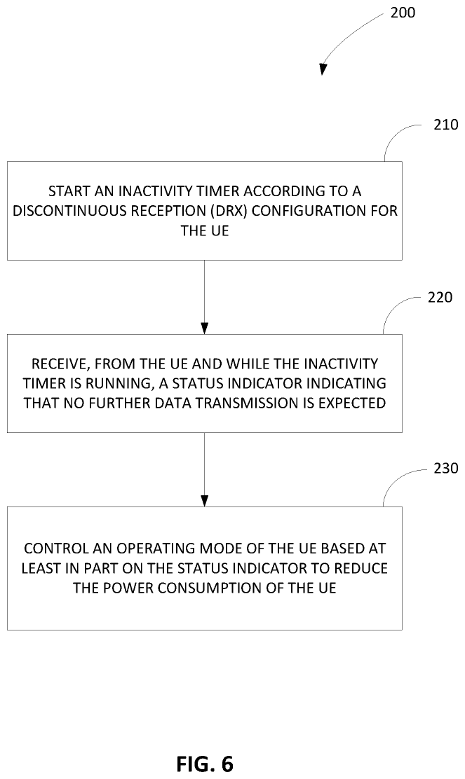

FIG. 6 illustrates an exemplary method 200 implemented by a base station 20 for reducing power consumption of a UE 30 served by the base station 20. The base station 20 starts an inactivity timer according to a discontinuous reception (DRX) configuration for the UE 30 with the UE 30 (block 210). The inactivity timer could be started when an allocation is made for the transmission, when the transmission begins, or when the transmission is complete. The base station 20 further receives, from the UE 30 and while the inactivity timer is running, a status indicator indicating that no further data transmission is expected (block 220). The base station 20 further controls an operating mode of the UE 30 based at least in part on the status indicator to reduce the power consumption of the UE 30 (block 230).

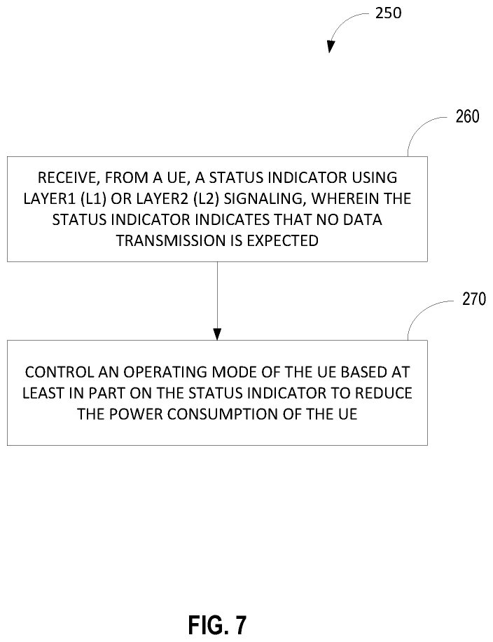

FIG. 7 illustrates another exemplary method 250 implemented by a base station 20 for reducing power consumption of a UE 30 served by the base station 20. The base station 20 receives, from the UE 30 using Layer1 (L1) or Layer2 (L2) signaling, a status indicator indicating that no further data transmission is expected (block 260). The base station 20 further controls an operating mode of the UE 30 based at least in part on the status indicator to reduce the power consumption of the UE 30 (block 270).

In some embodiments of methods 200 and 250, the status indicator indicates that no uplink transmission is expected.

In some embodiments of methods 200 and 250, the status indicator indicates that no downlink transmission is expected.

In some embodiments of methods 200 and 250, the status indicator indicates that neither an uplink transmission nor a downlink transmission is expected.

In some embodiments of the methods 200 and 250, the status indicator further comprises a time indication indicative of a time period during which not data transmission is expected.

In some embodiments of methods 200 and 250, controlling an operating mode of the UE 30 based at least in part on the status indicator comprises transmitting a control message to the UE 30 to cause the UE 30 to change its operating mode.

In some embodiments of methods 200 and 250, transmitting a control message to the UE 30 to cause the UE 30 to change its operating mode comprises transmitting a go-to-sleep signal to cause the UE 30 to switch from an active mode to a DRX mode.

In some embodiments of methods 200 and 250, the control message comprises a command to switch early from a short DRX cycle to a long DRX cycle.

In some embodiments of methods 200 and 250, transmitting a control message to the UE to cause the UE to change its operating mode comprises transmitting a configuration message to change a DRX configuration of the UE. For example, the configuration information could be used to change the length of a DRX cycle, or to change the duration of the inactivity timer. Those skilled in the art will appreciate that any change of DRX configuration that reduces UE power consumption could be made.

In some embodiments of methods 200 and 250, transmitting a control message to the UE 30 to cause the UE 30 to change its operating mode comprises transmitting a release message to the UE 30 to cause the UE 30 to change from a Connected state to an Idle state or Inactive state.

In some embodiments of methods 200 and 250, transmitting a control message to the UE 30 to cause the UE 30 to change its operating mode comprises transmitting a release signal to cause the UE 30 using carrier aggregation to remove a cell from a set of aggregated carriers.

In some embodiments of methods 200 and 250, receiving a status indicator from the UE 30 comprises receiving the status indicator in uplink control information transmitted on a shared uplink control channel.

In some embodiments of methods 200 and 250, receiving the status indicator in uplink control information comprises receiving the status indicator multiplexed with other control information transmitted on the shared uplink control channel.

In some embodiments of methods 200 and 250, receiving the status indicator in uplink control information comprises receiving the status indicator in a MAC CE transmitted on an uplink shared channel.

Some embodiments of methods 200 and 250 further comprise sending configuration information to the UE 30 configuring the UE 30 to transmit a negative scheduling request during operation of the inactivity timer to serve as the status indicator.

In some embodiments of methods 200 and 250, receiving a status indicator from the UE 30 comprises receiving the status indicator on an uplink shared channel used for transmission of user data.

In some embodiments of methods 200 and 250, receiving the status indicator on an uplink shared channel comprises transmitting the status indicator in a MAC CE.

In some embodiments of methods 200 and 250, receiving the status indicator on an uplink shared channel comprises multiplexing the status indicator with user data.

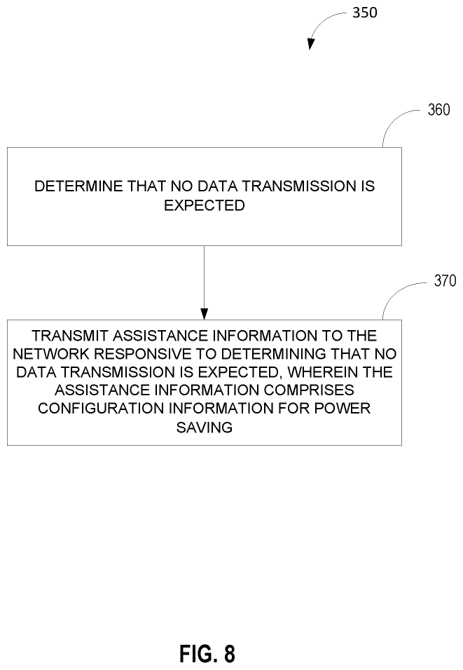

FIG. 8 illustrates another method 350 implemented by a UE 30 for providing assistance information for reducing power consumption. The UE 30 determines that no data transmission is expected (block 360). Responsive to determining that no data transmission is expected, the UE 30 transmits assistance information to the network 10 (block 370). The assistance information comprises configuration information for power saving.

In some embodiments of the method 350, the configuration information relates to a secondary cell configuration for power saving. For example, the configuration information may indicate a preference for one or more secondary cells that are currently configured. The network 10 may use the indication of the preference to select one or more SCells for release.

In some embodiments of the method 350, the configuration information relates to DRX configuration for power saving. For example, the configuration information may comprise a suggested/preferred DRX cycle length, or other preferred DRX parameters.

In some embodiments of the method 350, the assistance information further comprises a status indicator indicating that no further data transmission is expected.

In some embodiments of the method 350, the status indicator indicates that no uplink transmission is expected, no downlink transmission is expected, or both.

In some embodiments of the method 350, the assistance information further comprises a time indication indicative of a time period during which not data transmission is expected.

Some embodiments of the method 350 further comprise receiving, responsive to the assistance information, a control message from the network, and changing a mode of operation responsive to the control message.

In some embodiments of the method 350, the control message comprises a go-to-sleep signal; and the method 350 further comprises switching from an active mode to a DRX mode before expiration of the inactivity timer.

In some embodiments of the method 350, the control message comprises a configuration message; and the method 350 further comprises changing a DRX configuration of the UE responsive to the control message.

In some embodiments of the method 350, the control message comprises a release message; and the method 350 further comprises switching from a Connected state to an Idle state or Inactive state.

In some embodiments of the method 350, the control message comprises a release message; and the method 350 further comprises removing a secondary cell form a set of aggregated carriers.

In some embodiments of the method 350, the status indicator is transmitted in uplink control information transmitted on a shared uplink control channel.

In some embodiments of the method 350, the status indicator is transmitted in a Medium Access Control (MAC) control element.

In some embodiments of the method 350, the status indicator is transmitted in radio resource control (RRC) signaling.

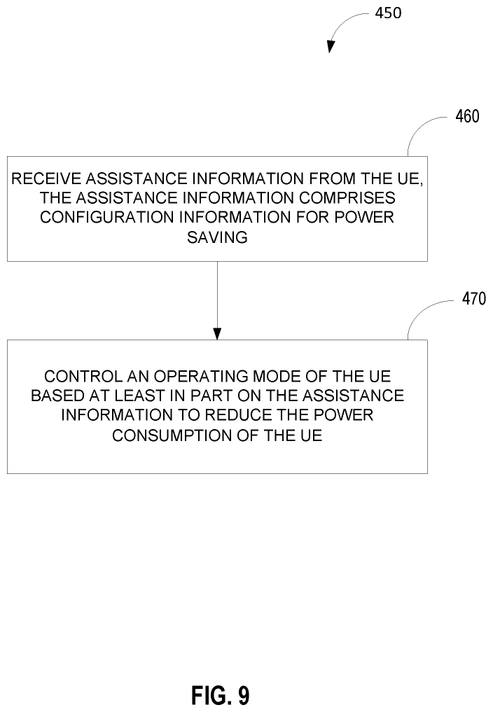

FIG. 9 illustrates another method 450 implemented by a base station 20 for reducing power consumption of a UE in a wireless communication network 10. The base station 20 receives assistance information from the UE 30 (block 460). The base station 20 further controls an operating mode of the UE 30 based at least in part on the assistance information to reduce the power consumption of the UE 30 (block 470).

In some embodiments of the method 450, the configuration information relates to a secondary cell configuration for power saving. For example, the configuration information may indicate a preference for one or more secondary cells that are currently configured. The base station 20 uses the indication of the preference to select one or more SCells for release.

In some embodiments of the method 450, the configuration information relates to DRX configuration for power saving. For example, the configuration information may comprise a suggested/preferred DRX cycle length, or other preferred DRX parameters. The base station 20 uses the preferred DRX parameters to configure DRX for the UE 30.

In some embodiments of the method 450, the assistance information further comprises a status indicator indicating that no further data transmission is expected.

In some embodiments of the method 450, the status indicator indicates that no uplink transmission is expected, no downlink transmission is expected, or both.

In some embodiments of the method 450, the assistance information further comprises a time indication indicative of a time period during which not data transmission is expected.

In some embodiments of the method 450, controlling an operating mode of the UE based at least in part on the status indicator comprises transmitting a control message to the UE to cause the UE to change its operating mode.

In some embodiments of the method 450, the control message comprises a go-to-sleep signal to cause the UE to switch from an active mode to a DRX mode.

In some embodiments of the method 450, the control message comprises a configuration message to change a DRX configuration of the UE.

In some embodiments of the method 450, the control message comprises a release message to cause the UE to change from a Connected state to an Idle state or Inactive state.

In some embodiments of the method 450, the control message comprises a release message to cause the UE using carrier aggregation to remove a secondary cell from a set of aggregated carriers.

In some embodiments of the method 450, the assistance information is received in uplink control information transmitted on a shared uplink control channel.

In some embodiments of the method 450, the assistance information is received in a Medium Access Control (MAC) control element.

In some embodiments of the method 450, the assistance information is received in radio resource control signaling.

Apparatuses configured to perform the methods as herein described can be implemented by any functional means, modules, units, or circuitry. In one embodiment, for example, the apparatuses comprise respective circuits or circuitry configured to perform the method shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

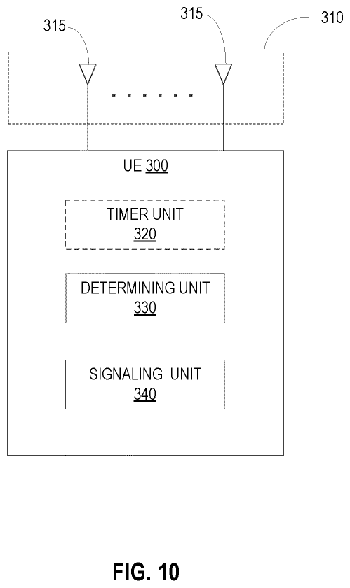

FIG. 10 illustrates a UE 300 configured to implement one or more of the methods 100, 150 and 175 as herein described. The UE 300 comprises an antenna array 310 having one more antennas 315, an optional timer unit 320, a determining unit 330 and a signaling unit 340. The units 320-340 can be implemented by hardware and/or by software code that is executed by one or more processors or processing circuits. The timer unit 320, if present, is configured to start an inactivity timer according to a discontinuous reception (DRX) configuration responsive to an uplink or downlink transmission. The determining unit 330 is configured to monitor the status of data transmission and determine when no data transmission is expected. In one embodiment, the transmitting unit 340 is configured to transmit, responsive to determining that no data transmission is expected, a status indicator to the network indicating that no further data transmission is expected. In an alternate embodiment including the timer unit 320, the transmitting unit 340 is configured to transmit, responsive to determining that no data transmission is expected, a status indicator to the network while the inactivity timer is running, wherein the status indicator indicates that no further data transmission is expected.

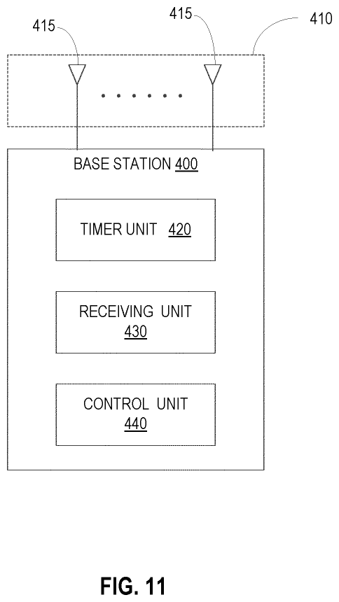

FIG. 11 illustrates a base station (e.g. eNB or gNB) 400 configured to implements the methods 200-250 as herein described. The base station 400 comprises an antenna array 410 having one more antennas 415, an optional timer unit 420, a determining unit 430 and a control unit 440. The units 420-440 can be implemented by hardware and/or by software code that is executed by one or more processors or processing circuits. The timer unit 420, if present, is configured to start an inactivity timer according to a discontinuous reception (DRX) configuration responsive to an uplink or downlink transmission with the UE 30. In one embodiment including the timer unit 420, the receiving unit 430 is configured to receive, from the UE 30 while the inactivity timer is running, a status indicator indicating that no further data transmission is expected. In an alternative embodiment, the receiving unit 430 is configured to receive, from a UE 30, a status indicator using layer1 (L1) or layer2 L2) signaling, wherein the status indicator indicates that no data transmission is expected. The control unit 440 is configured to control an operating mode of the UE 30 based at least in part on the status indicator to reduce the power consumption of the UE 30.

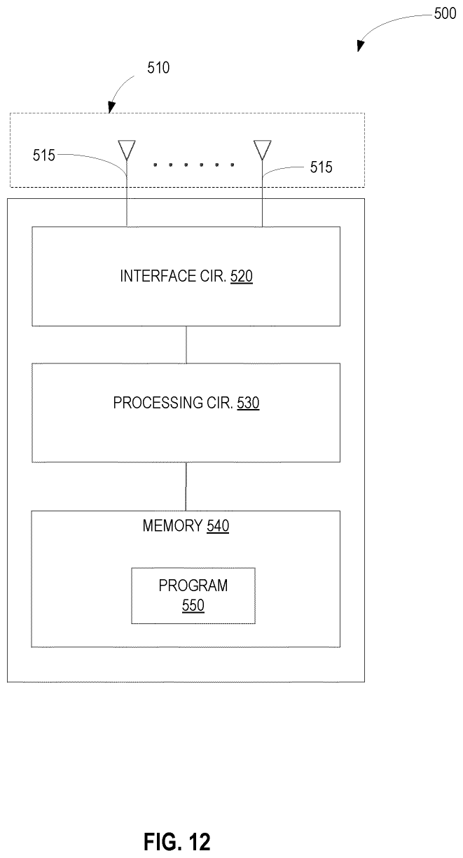

FIG. 12 illustrates a UE 500 according to another embodiment that is configured to implement the methods as herein described. The UE 500 comprises an antenna array 510 comprising one or more antenna 515, a communication circuit 520 coupled to the antenna array 510, a processing circuit 530, and memory 540.

The communication circuit 520 comprises radio frequency (RF) circuits (e.g., transmitter and receiver) needed for transmitting and receiving signals over a wireless communication channel. In one embodiment, the communication circuit are configured to operate according to the NR standard.

The processing circuit 530 controls the overall operation of the UE 500 and can be configured to perform one or both of the methods 100, 150, 175 and 350 shown in FIGS. 3-5 and 8 respectively. The processing circuit 530 may comprise one or more microprocessors, hardware, firmware, or a combination thereof.

Memory 540 comprises both volatile and non-volatile memory for storing computer program code and data needed by the processing circuit 530 for operation. Memory 540 may comprise any tangible, non-transitory computer-readable storage medium for storing data including electronic, magnetic, optical, electromagnetic, or semiconductor data storage. Memory 540 stores a computer program 550 comprising executable instructions that configure the processing circuit 530 to implement one or more of the methods 100, 150, 175 and 350 according to FIGS. 3-5 and 8 respectively. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 550 for configuring the processing circuit 530 as herein described may be stored in a removable memory, such as a portable compact disc, portable digital video disc, or other removable media. The computer program 550 may also be embodied in a carrier such as an electronic signal, optical signal, radio signal, or computer readable storage medium.

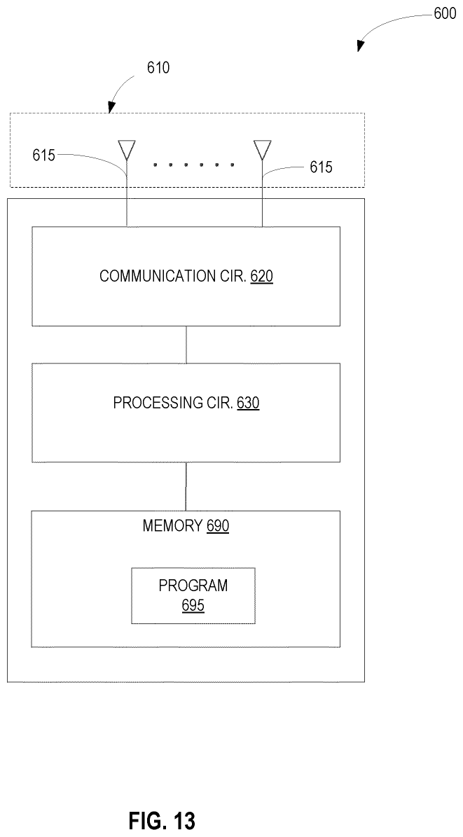

FIG. 13 illustrates a base station 600 according to another embodiment that is configured to implement the methods as herein described. The base station 600 comprises an antenna array 610 comprising one or more antenna 616, a communication circuit 620 coupled to the antenna array 610, a processing circuit 630, and memory 640.

The communication circuit 620 comprises radio frequency (RF) circuits (e.g., transmitter and receiver) needed for transmitting and receiving signals over a wireless communication channel. In one embodiment, the communication circuit are configured to operate according to the NR standard.

The processing circuit 630 controls the overall operation of the base station 600 and can be configured to perform one or both of the methods 200 and 250 shown in FIGS. 6, 7 and 9 respectively. The processing circuit 630 may comprise one or more microprocessors, hardware, firmware, or a combination thereof.

Memory 640 comprises both volatile and non-volatile memory for storing computer program code and data needed by the processing circuit 630 for operation. Memory 640 may comprise any tangible, non-transitory computer-readable storage medium for storing data including electronic, magnetic, optical, electromagnetic, or semiconductor data storage. Memory 640 stores a computer program 650 comprising executable instructions that configure the processing circuit 630 to implement one or more of the methods 200, 250 and 450 according to FIGS. 6, 7 and 9 respectively. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 650 for configuring the processing circuit 630 as herein described may be stored in a removable memory, such as a portable compact disc, portable digital video disc, or other removable media. The computer program 650 may also be embodied in a carrier such as an electronic signal, optical signal, radio signal, or computer readable storage medium.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

The RAI mechanisms herein described help the network 10 in deciding whether to release the UE 30 for long term (as in RRC release), or short term (as in DRX command), or whether to release Scell(s). As such, the UE 30 can save some power while its throughput and latency remains largely intact. Furthermore, the techniques herein described enable faster RAI signaling with respect to the state of the art while still being robust.

### Additional Embodiments

Additional embodiments will now be described. At least some of these embodiments may be described as applicable in certain contexts and/or wireless network types for illustrative purposes, but the embodiments are similarly applicable in other contexts and/or wireless network types not explicitly described.

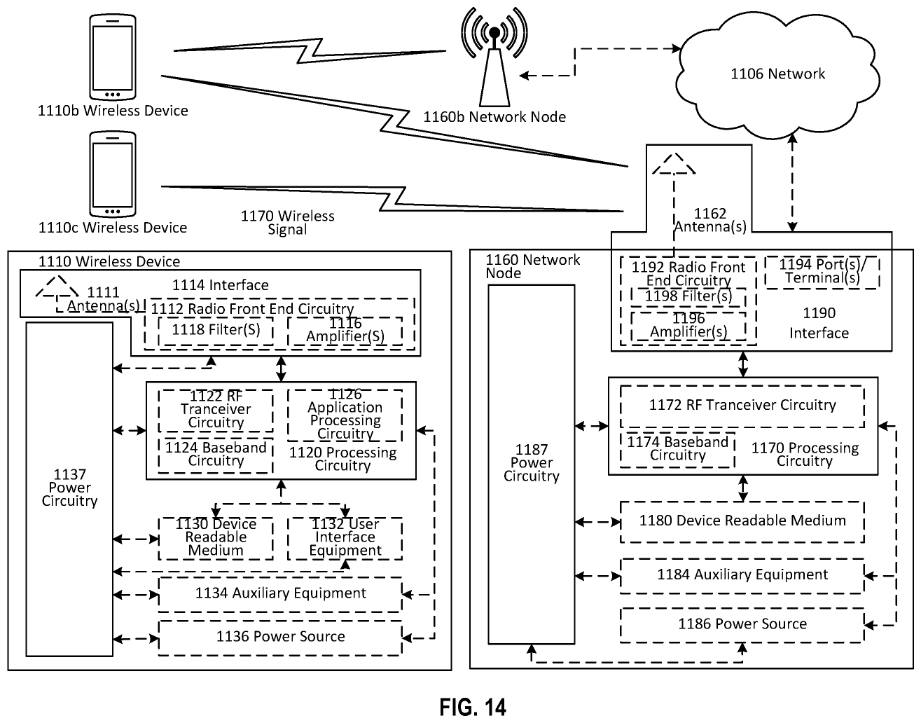

Although the subject matter described herein may be implemented in any appropriate type of system using any suitable components, the embodiments disclosed herein are described in relation to a wireless network, such as the example wireless network illustrated in FIG. 14. For simplicity, the wireless network of FIG. 14 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 14, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 14 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signaling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 14 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110.

Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

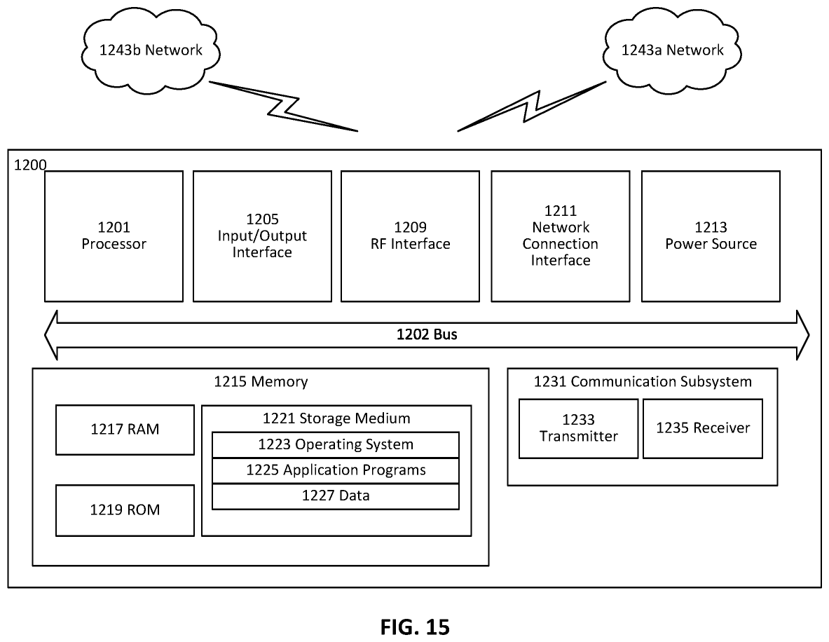

FIG. 15 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 12200 may be any UE identified by the 3rd Generation Partnership Project (3GPP), including a NB-IoT UE, a machine type communication (MTC) UE, and/or an enhanced MTC (eMTC) UE. UE 1200, as illustrated in FIG. 13, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 15 is a UE, the components discussed herein are equally applicable to a WD, and vice-versa.

In FIG. 15, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 15, or only a subset of the components. The level of integration between the components may vary from one UE to another UE. Further, certain UEs may contain multiple instances of a component, such as multiple processors, memories, transceivers, transmitters, receivers, etc.

In FIG. 15, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 15, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 15, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

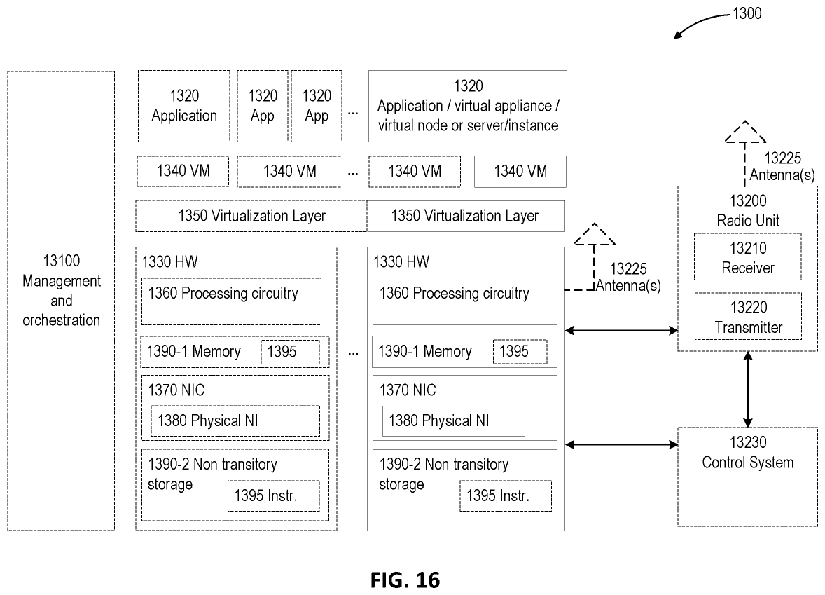

FIG. 16 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 16, hardware 1330 may be a standalone network node with generic or specific components. Hardware 1330 may comprise antenna 13225 and may implement some functions via virtualization. Alternatively, hardware 1330 may be part of a larger cluster of hardware (e.g., such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 13.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signaling can be effected with the use of control system 13230 which may alternatively be used for communication between the hardware nodes 1330 and radio units 13200.

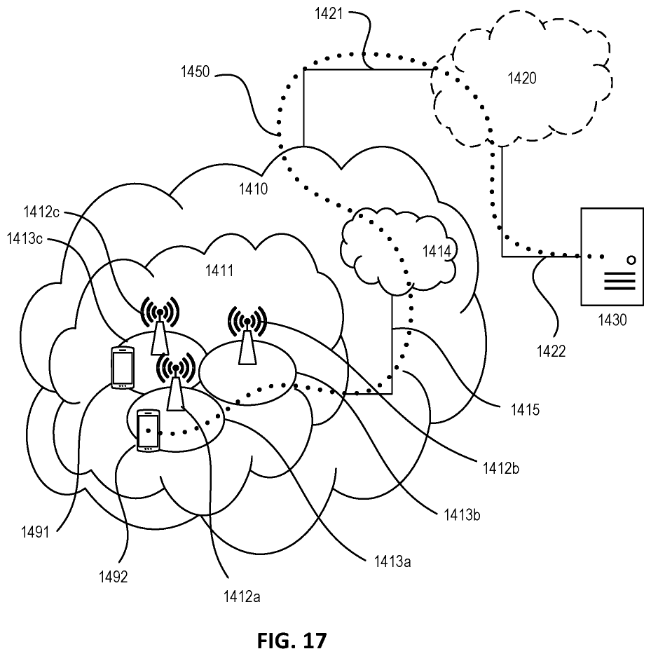

FIG. 17 illustrates a telecommunication network connected via an intermediate network to a host computer in accordance with some embodiments. In particular, with reference to FIG. 17, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, and a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 17 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

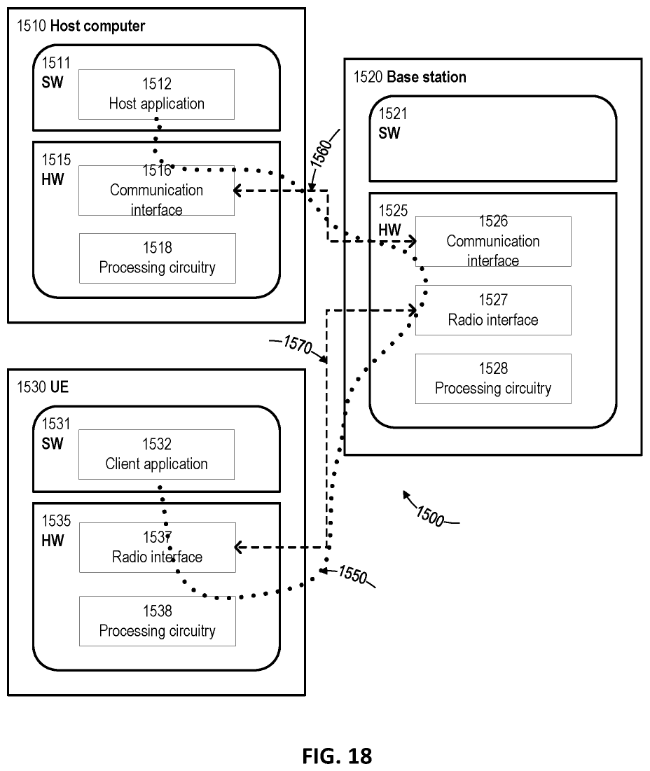

Example implementations, in accordance with an embodiment, of the UE, base station and host computer discussed in the preceding paragraphs will now be described with reference to FIG. 18. FIG. 18 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 18) served by base station 1520. Communication interface 1526 may be configured to facilitate connection 1560 to host computer 1510. Connection 1560 may be direct or it may pass through a core network (not shown in FIG. 18) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 15 may be similar or identical to host computer 1430, one of base stations 1412a, 1412b, 1412c and one of UEs 1491, 1492 of FIG. 14, respectively. This is to say, the inner workings of these entities may be as shown in FIG. 15 and independently, the surrounding network topology may be that of FIG. 14.

In FIG. 18, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments may improve the power consumption of a wireless device or user equipment and thereby provide benefits such as longer battery life between recharging.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510's measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

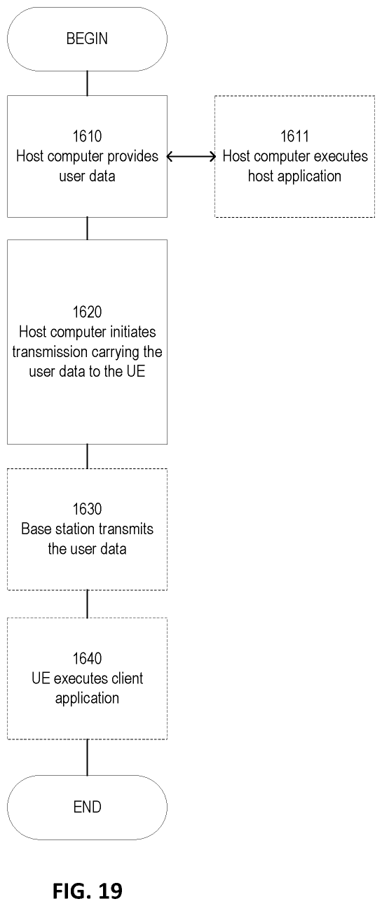

FIG. 19 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 16 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

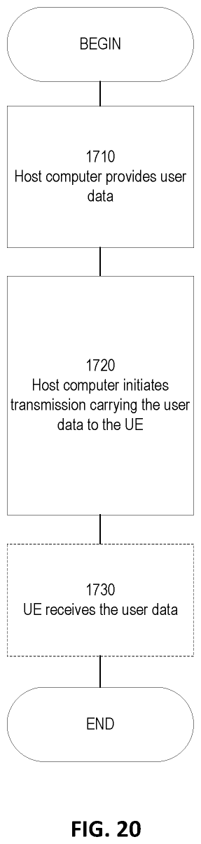

FIG. 20 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 20 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

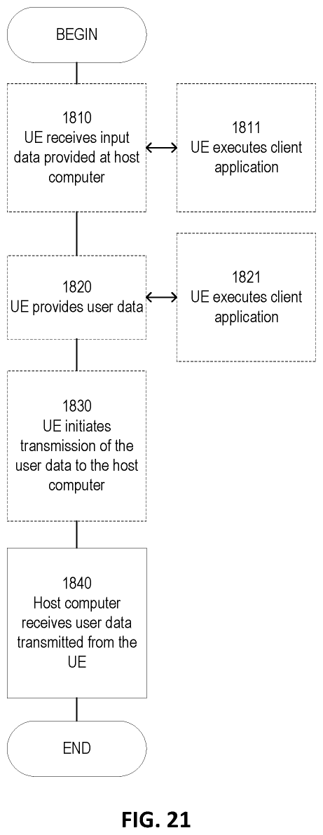

FIG. 21 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 21 will be included in this section. In step 1810 (which may be optional), the UE receives input data provided by the host computer. Additionally, or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

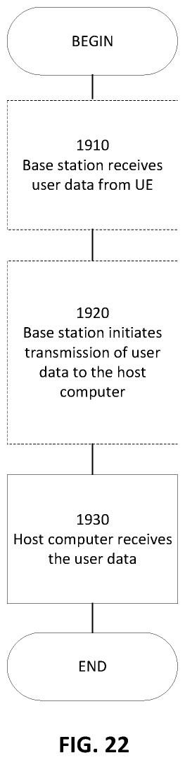

FIG. 22 is a flowchart illustrating a method implemented in a communication system, in accordance with one embodiment. The communication system includes a host computer, a base station and a UE which may be those described with reference to FIGS. 17 and 18. For simplicity of the present disclosure, only drawing references to FIG. 22 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. Additional information and embodiments may also be found in Appendices A and B attached hereto.

1-40. (canceled)

41. A method, implemented by a UE, of signaling assistance information for reducing power consumption by a UE, the method comprising:
determining that no data transmission is expected; and
transmitting assistance information to the network responsive to determining that no data transmission is expected, wherein the assistance information comprises configuration information for power saving.

42. The method of claim 41, wherein the configuration information relates to a secondary cell configuration for power saving.

43. The method of claim 41, wherein the configuration information relates to DRX configuration for power saving.

44. The method of claim 41, wherein the assistance information further comprises a status indicator indicating that no further data transmission is expected.

45. The method of claim 44, wherein the status indicator indicates that no uplink transmission is expected, no downlink transmission is expected, or both.

46. The method of claim 41, further comprising:
receiving, responsive to the assistance information, a control message from the network; and
changing a mode of operation responsive to the control message.

47. The method of claim 46:
wherein the control message comprises a go-to-sleep signal; and
wherein the method further comprises switching from an active mode to a DRX mode before expiration of the inactivity timer.

48. The method of claim 46:
wherein the control message comprises a configuration message; and
wherein the method further comprises changing a DRX configuration of the UE responsive to the control message.

49. The method of claim 46:
wherein the control message comprises a release message; and
wherein the method further comprises switching from a Connected mode to an Idle state or Inactive state.

50. The method of claim 46:
wherein the control message comprises a release message; and
wherein the method further comprises removing a secondary cell form a set of aggregated carriers.

51. A method, implemented by a base station, for reducing power consumption of a User Equipment (UE) in a wireless communication network, the method comprising:
receiving assistance information from the UE, the assistance information comprising configuration information for power saving; and
controlling an operating mode of the UE based at least in part on the assistance information to reduce the power consumption of the UE.

52. The method of claim 51, wherein the configuration information relates to a secondary cell configuration for power saving.

53. The method of claim 51, wherein the configuration information relates to DRX configuration for power saving.

54. The method of claim 51, wherein the assistance information further comprises a status indicator indicating that no further data transmission is expected.

55. The method of claim 54, wherein the status indicator indicates that no uplink transmission is expected, no downlink transmission is expected, or both.

56. The method of claim 55, wherein the assistance information further comprises a time indication indicative of a time period during which not data transmission is expected.

57. The method of claim 51, wherein controlling the operating mode of the UE based at least in part on the status indicator comprises transmitting a control message to the UE to cause the UE to change its operating mode.

58. The method of claim 51, wherein the control message comprises:
a go-to-sleep signal to cause the UE to switch from an active mode to a DRX mode;
a configuration message to change a DRX configuration of the UE;
a release message to cause the UE to change from a Connected state to an Idle state or Inactive state; or
a release message to cause the UE using carrier aggregation to remove a secondary cell from a set of aggregated carriers.

59. A user equipment in a wireless communication network, the user equipment comprising:
processing circuitry;
memory containing instructions executable by the processing circuitry whereby the user equipment is operative to:
determine that no data transmission is expected; and
transmit assistance information to the network responsive to determining that no data transmission is expected, wherein the assistance information comprises configuration information for power saving.

60. A base station in a wireless communication network, the base station comprising:
processing circuitry;
memory containing instructions executable by the processing circuitry whereby the base station is operative to:
receive assistance information from a User Equipment (UE), the assistance information comprises configuration information for power saving; and
control an operating mode of the UE based at least in part on the assistance information to reduce the power consumption of the UE
